(19) United States
(12) Patent Application Publication
(10) Pub. No.: US 2007/0094366 A1
(43) Pub. Date: Apr. 26, 2007

(54) System and method for real-time processing and distribution of media content in a network of media devices

(76) Inventor: Ramy P. Ayoub, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/254,365

(22) Filed: Oct. 20, 2005

(51) Int. Cl. G06F 15/173

(52) U.S. Cl. 709/223

(57) ABSTRACT

A system and method for managing media content between media devices is disclosed. In a centralized embodiment, a server monitors the media devices actively connected to the network and maintains information on each of the active media devices. The information includes the functions of each of the active media devices for processing media content. The server receives a request for media content and determines functions required to process the media content. The server then determines which of the active media devices have the required functions to process the media content and sends instructions to the determined media devices to configure processing of the media content. In response, the determined media devices process the media content, and the processed media content is delivered at the requesting media device. In a decentralized embodiment, the functions performed by the server are distributed among the various devices of the network.

### CROSS-REFERENCE TO RELATED APPLICATIONS

This application is filed concurrently with U.S. patent application having Express Mail No. ED 869153144 US, Attorney Docket No. IS01951TC, and entitled “System and Method for Obtaining and Managing Restricted Media Content in a Network of Media Devices.”

### FIELD OF THE DISCLOSURE

The subject matter of the present disclosure relates to a system and method for real-time processing and distribution of media content in a network of media devices.

### BACKGROUND OF THE DISCLOSURE

Various devices for delivering media content to a user are known in the art. Examples of such media devices include music servers, portable electronic devices, cellular communication devices, home entertainment systems, personal computers, and vehicular entertainment systems. Typical types of media content that can be delivered to a user by such media devices include multi-media data, audio data, video data, Internet data, cable broadcast data, radio broadcast data, satellite broadcast data, and television broadcast data. To deliver the media content to a user, the media devices must be capable of performing various functions or must have certain capabilities, such as processing, storing, rendering, encoding, decoding, transcoding, parsing, encrypting, decrypting, streaming, communicating, and playing the media content. A user may own a number of media devices with different functions and capabilities. Therefore, it would be advantageous to connect a user's media devices in a network and to manage and distribute the various functions and capabilities of the networked media devices in real time so that the media content can be delivered effectively to the user.

In general, data networks are known in the art where processing loads can be managed and distributed among servers in the network based on the individual loads and capabilities of those servers. For example, servers can cooperate together by using load balancing to ensure that the server with the least amount of load gets more of the compiling/linking load. However, building software executables across servers involves functions and capabilities quite different from those involved with processing, storing, and delivering media content. For one, the various servers are typically share redundant capabilities so that the servers are essentially interchangeable with one another to perform the tasks required. In addition, the load balancing used to build software is not preformed in real-time, which is necessary for delivering media content to a user.

The subject matter of the present disclosure is directed to overcoming, or at least reducing the effects of, one or more of the problems set forth above.

### BRIEF DESCRIPTION OF THE DRAWINGS

FIG. 1 illustrates an embodiment of a media network according to certain teachings of the present disclosure.

FIG. 2 illustrates an embodiment of a centralized media network according to certain teachings of the present disclosure.

FIG. 3 illustrates an embodiment of a master manifest file shown in chart form.

FIG. 4 illustrates, in flowchart form, an embodiment of a process for negotiating the functions and capabilities of media devices in a centralized media network according to certain teachings of the present disclosure.

FIG. 5 illustrates an embodiment of a distributed media network according to certain teachings of the present disclosure.

FIG. 6 illustrates, in flowchart form, an embodiment of a process for negotiating the functions and capabilities of media devices when a device enters a distributed media network according to certain teachings of the present disclosure.

FIG. 7 illustrates, in flowchart form, an embodiment of a process for reallocating and updating the functions and capabilities of media devices when a device leaves a distributed media network according to certain teachings of the present disclosure.

While the disclosed system and method are susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

Systems and methods for managing media content between media devices are disclosed. In one embodiment, the media devices are connected in a centralized media network having a central server. The central server monitors the media devices actively connected to the network and maintains information on each of the active media devices in a master manifest file. The information maintained by the server includes the resources available on the network. Preferably, the information of available resources includes current communication data, current processing usage of the media devices, and the capabilities or functions of each of the active media devices to store and/or process media content. In another embodiment, the media devices are connected in a decentralized or distributed media network, and the information of the active media devices is maintained at each of the active media devices instead of at a central server.

A user can request that certain media content available on the network be delivered to one of the media devices, such as a portable music player. When such a request for media content is received, a determination is made as to which resources (e.g., communication data, processing usage, capabilities, functions, etc.) are required to perform the request (i.e., deliver the requested media content to the user). Then, a determination is made as to which active media devices have the required resources to deliver the media content at the requested media device. Instructions are sent to the determined media devices to configure processing of the media content. In response, the determined media devices process the media content as instructed and communicate processed media content between each other so that the processed media content is delivered to the user at the requested media device.

The foregoing is not intended to summarize each potential embodiment or every aspect of the present disclosure. Let us now refer to the figures to describe the invention in greater detail.

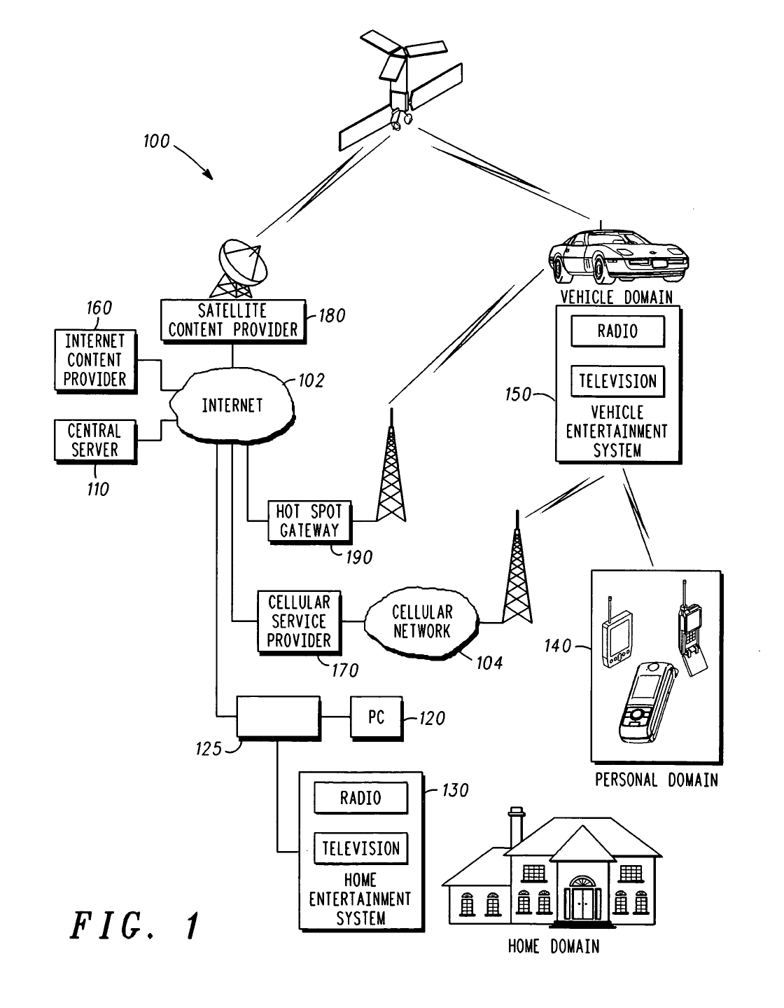

Referring to FIG. 1, an embodiment of a media network 100 according to certain teachings of the present disclosure is illustrated. The present embodiment of the media network 100 illustrates a variety of possibilities available for the systems and methods of the present disclosure. The media network 100 includes a plurality of media devices 120, 130, 140, and 150 capable of delivering media content (e.g., audio, video, data, etc.) to users in various domains. For example, one media device 150 can be in a vehicular domain and can be incorporated into a vehicle's head unit or entertainment system. One example of such a vehicle device 150 is referred to as a Telematic system, such as disclosed in U.S. patent application Ser. No. 11/118,528, filed Apr. 29, 2005, (Dkt. No. IS01598TC), which is incorporated herein by reference in its entirety. Other media devices 120 and 130 can be in a home domain and can be a music server, a personal computer, or a home entertainment system, for example. Still another media device 140 can be in a personal domain and can be a portable electronic device, such as a personal digital assistant (PDA), a digital music player, an iPod™, or a portable phone, for example. It is understood that other media devices known in the art can also be used in these and other domains of the network 100.

The media devices 120-150 can share media content with one another and can receive media content from any of a plurality of sources, including, but not limited to, an Internet provider 160, a cellular service provider 170, a satellite provider 180, a cable provider (not shown), and a radio provider (not shown). For example, the media devices 120-150 can receive broadcast content (audio and/or video) from the satellite content provider 180 and can receive broadcast content via radio signals from local content broadcasters (not shown). In another example, the media devices 120-150 can receive stored content from the Internet provider 160, which can provide stored music or video content to users. If the media device is a portable or mobile unit (such as the vehicle media device 150 or the portable media device 140), the media device may also be able to receive stored content from a home gateway 125 or a hot spot gateway 190 through a short-range communication system known in the art.

Using various communication links of the network 100, the media devices 120-150 can exchange and transfer data, instructions, and media content between the media devices 120-150 and providers 160-180. In various embodiments, the media devices 120-150 can also communicate with one another in the network 100 using any of a number of communication techniques known in the art. For example, one or more of the media devices 120-150 can include wireless transceivers capable of establishing wireless communication links through a wireless communication system, such as a cellular communication network 104. The cellular communication network 104 can operate according to wireless communication protocols known in the art, such as a Global System for Mobile Communications (GSM) protocol, a Code Division Multiple Access (CDMA) protocol, or a Time Division Multiple Access (TDMA) protocol. The cellular communication network 104 can be further coupled to the Internet 102 by the cellular service provider 170 or other wired network, allowing a cellular device to connect with another media device on the network 100. For example, the vehicle device 150 can be connected through the cellular network 104, the provider 170, and the Internet 102 to the home media devices 120, 130.

In additional examples, some of the media devices 120-150 can include wireless transceivers capable of establishing wireless communication links through short-range wireless communication systems or networks, including, but not limited to, a Bluetooth™ communication system and an IEEE 802.11 communication system. For example, the portable device 140 can establish direct communication with the vehicle device 150 using Bluetooth™ technology. In another example, a short-range wireless transceiver in the vehicle device 150 can establish direct wireless communication to another media device 120, 130 in the home through the home gateway 125 or can establish indirect wireless communication to another media device 120, 130 in the home through the hot spot gateway 190.

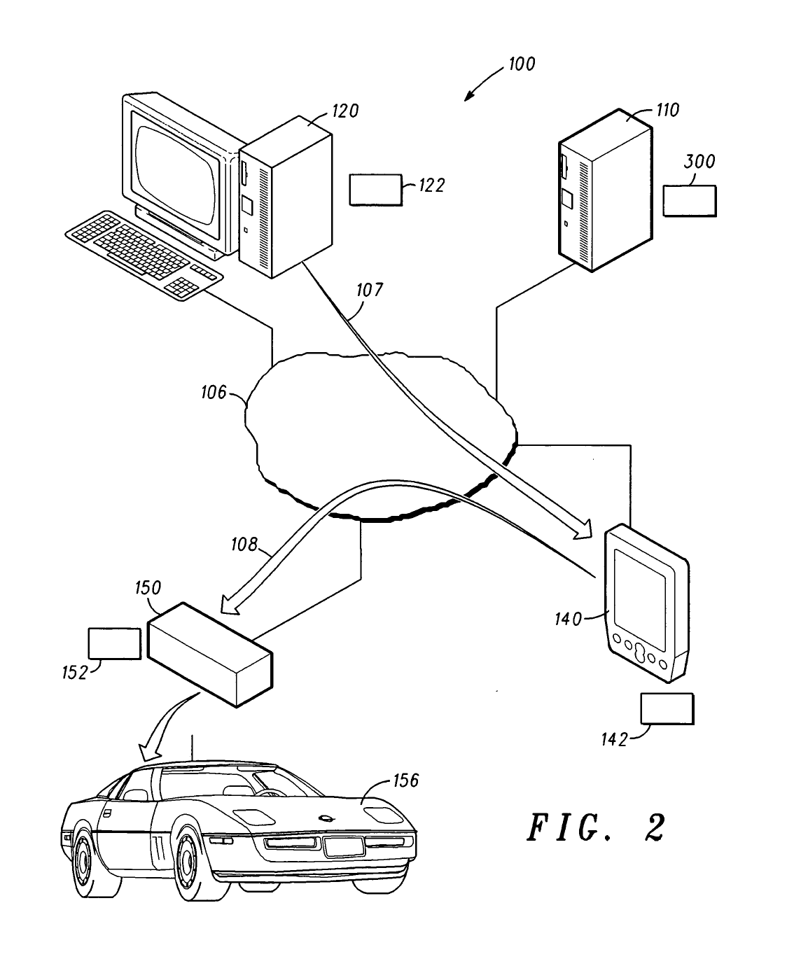

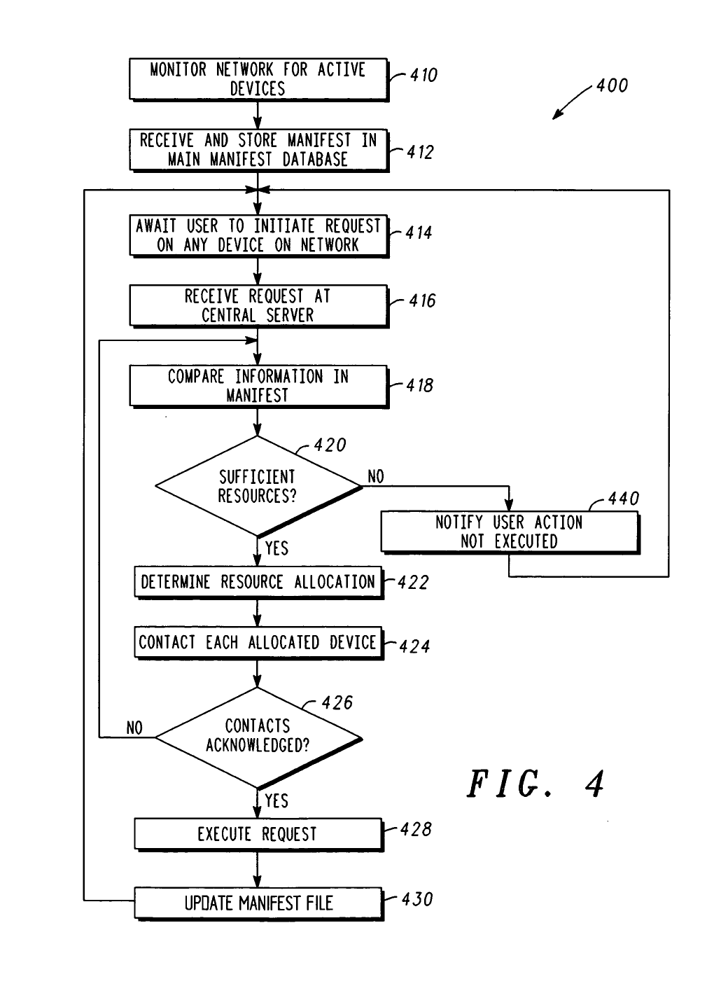

In one embodiment, the media network 100 is a centralized network and includes a central server 110, as shown in FIG. 1. The central server 110 hosts the communications between the media devices 120-150 and manages the distribution and processing of media content between media devices. The central server 110 can communicate with the media devices 120-150 through a combination of communication links that are wireless or wired. For example, the central server 110 can be an independent component of the network 100 that is connected to the Internet 102 and connected in turn to the media devices 120-150 by the various communication links disclosed herein. Such a centralized media network is disclosed in more detail below with reference to FIGS. 2 and 4.

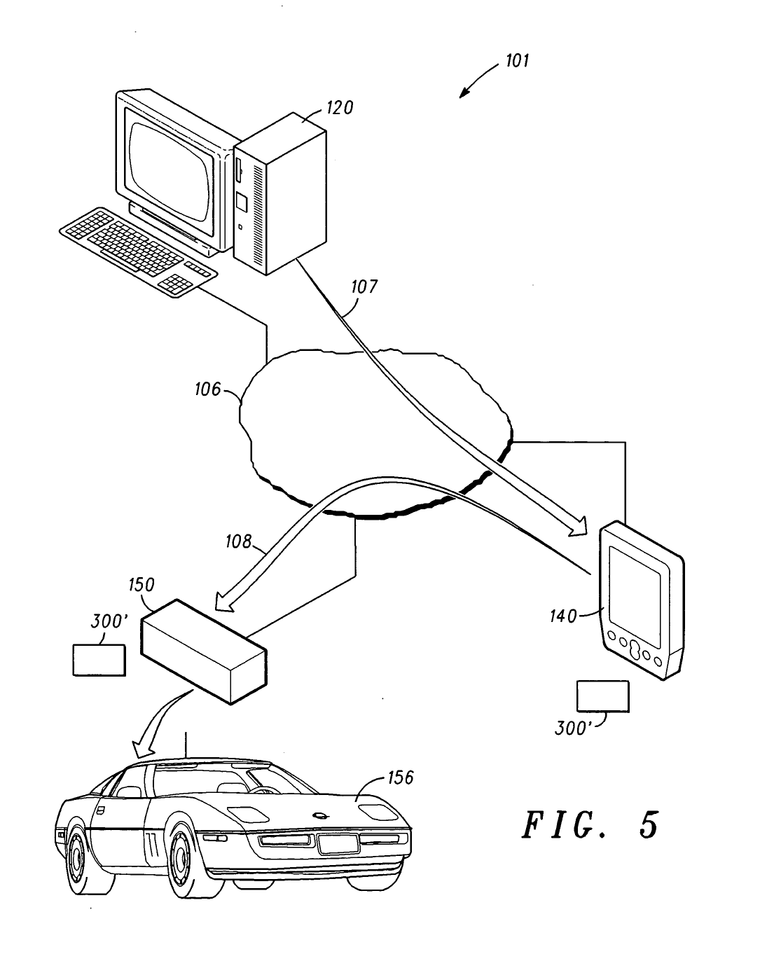

In another embodiment, the media network 100 is a decentralized or distributed network and does not include such a central server. Instead, functions for managing the media devices 120-150 can be incorporated into or distributed among the service providers, such as the Internet content provider 160, the cellular service provider 170, etc. Alternatively, functions for managing the media devices 120-150 can reside locally in one or more of the media devices 120-150. Such a decentralized media network is disclosed in more detail below with reference to FIGS. 5 through 7. Additional details concerning the media network 100 of the present disclosure are disclosed in U.S. patent application Ser. No. 11/118,528, filed Apr. 29, 2005, (Dkt. No. IS01598TC), which has been incorporated herein in its entirety.

Now that the context of a media network according to the present disclosure has been described, discussion now turns to how media content is managed, distributed, and processed in such a centralized media network.

Referring to FIG. 2, certain aspects of the media network 100 are illustrated in more detail. Again, the network 100 is centralized and includes central server 110. The network 100 also includes home device 120, personal device 140, and vehicle device 150, which are active on the network 100. It is understood, however, that the disclosed network 100 can have any number of media devices known in the art. The server 110 and the media devices 120, 140, and 150 are connected together by various network paths, which are only schematically represented in FIG. 2 by element 106 and which can include the Internet, cellular wireless communication, Bluetooth™ communication, IEEE 802.11 communication, and combinations thereof, for example.

In the present example, the server 110 is a remote server connected by a high-speed Internet path of network 106, and the music device 120 is a personal computer at a user's home that is also connected by a high-speed Internet path of network 106. Alternatively, for example, the music device 120 can be an independent source on the Internet for music. The personal device 140 is a portable music player connecting to network 106 by a cellular wireless communication path, which in turn can connect with the Internet by techniques known the art. The vehicle device 150 is a Telematic system in a vehicle 156 that connects to network 106 by cellular wireless communication path, which in turn can connect with the Internet by techniques known the art. The devices 120, 140, and 150 may also be capable of connecting to network 106 by short-range communication with one another using direct links, Bluetooth™ communication, or IEEE 802.11 communication, for example.

The server 110 gathers information on the media devices 120, 140, and 150 active on the network 100. For example, the server 110 detects all of the active media devices 120, 140, and 150 that have entered the network 100 and maintains a master manifest file 300 for storing information concerning the media devices 120, 140, and 150. Each device 120, 140, and 150 on the network 100 also preferably compiles its own manifest file 122, 142, and 152, which it can send to the server 110 or which the server 110 can query for incorporation into the master manifest file 300. For example, the active devices 120, 140, and 150 on the network 100 can be configured to send current information routinely to the server 110 to update the master manifest file 300 using techniques known in the art. Alternatively, the server 110 can periodically poll for media devices active or connected on the network 100 to obtain current information for the master manifest file 300 using techniques known in the art.

The server 110 uses the information in the master manifest file 300 to manage the delivery of media content in the network 100. Various forms of information on the media devices 120, 140, and 150 can be maintained in the manifest file(s) (300, 122, 142, and 152) depending on the particular implementation of the disclosed network 100. In general, the master manifest file 300 contains the “resources” available on the network 100. The network resources in the manifest file 300 include content processing functionalities or capabilities of each of the media devices 120, 140, and 150 to process media content. Each of the media devices 120, 140, and 150 may have differing capabilities.

The content processing capabilities include converting media content into a streamable form with one device and streaming that streamable form to another device via a communication path. For example, the content processing capabilities include the ability of a media device to encode, decode, render, parse, and stream certain types, files, or formats of media content. The content processing capabilities can also include the ability of a media device to transcode or otherwise convert one type, file, or format of media content to another type, file, or format. In addition, the network resources in the manifest file 300 include the current processor usage for the media devices 120, 140, and 150, the throughput capacity of the communication paths of the media devices, and the processing speeds of the media devices.

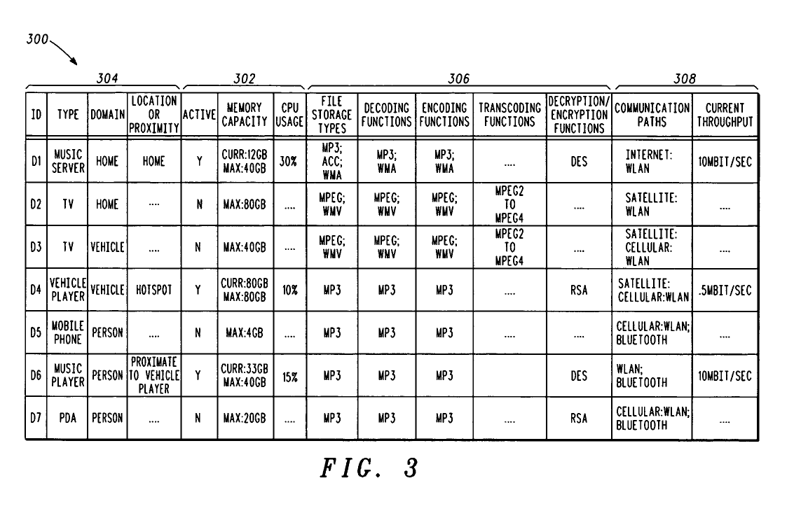

An embodiment of the master manifest file 300 is shown in FIG. 3. Although shown in a chart form for illustrative purposes, the master manifest file 300 can be maintained in any manner known in the art, such as part of a database associated with a server. In the present example, each of the media devices are listed in the manifest file 300, but only information from active media devices may be used. The manifest file 300 has attributes or information 302 concerning the memory and processor capabilities of the media devices, information 304 for identifying the media devices (e.g., the device's ID, type, and domain), information 306 on the processing capabilities of the media devices, and information 308 on communication capabilities of the media devices. These various attributes in the master manifest file 300 are merely exemplary, and other information can be entered and used as well, depending on the particular implementation.

The device information 302 includes an indication whether the media device is active on the media network, an indication of the processor usage of the media device, and an indication of the storage capacity of the media device. These indications can be routinely updated. The identifying information 304 is specific to the media device and includes the media device's identification and its domain. The identifying information 304 may also include other information, such as the device's current location, which may be indicated by its domain designation or by GPS or other means in the case of a mobile device.

The processing information 306 provides the functions or capabilities of the media device to process media content. For example, the processing information 306 includes, but is not limited to, types of files that a media device can store, multimedia decoding functions (e.g., MP3 decoders for audio play), multimedia encoding functions (e.g., MP3 encoders for audio capture), and multi-media transcoding functions (e.g., functions for converting from MPEG2 to MPEG4). Although not shown, the processing information 306 can also indicate the processing speed of the media device.

The communication information 308 indicates the types of communication that the media device is capable of performing. For example, the communication information 308 can indicate if a media device is capable of Cellular, VoIP, GPRS for Cellular, Wireless LAN, Bluetooth™, communication with a short-range transceiver, and communication with a cellular transceiver. The communication information 308 also includes throughput characteristics (i.e., the communication speed of a current network connection for the media device). Although not shown in FIG. 3, the communication information can also include Quality of Service (QoS) information. The concept of QoS information is known in the art, and the QoS information can indicate the efficiency of the various communication paths of the network.

Some media content available on the network may be restricted media content protected by a Digital Rights Management (DRM) scheme. When requested media content is restricted, a media device must have proper digital rights to be able to process that restricted media content. Accordingly, information 306 in the manifest file 300 shown in FIG. 3 can further include security information, such as encryption, decryption, secure storage capabilities, and DRM information of the media devices. For example, information 306 can indicate decryption techniques used by the media devices, such as the Data Encryption Standard (DES) and the RSA encryption algorithm. In addition, for example, a media device may be a trusted Helix player and may be used to render media that has Helix DRM protection. Such information can be contained in the manifest 300 and used to manage the processing and delivery of media content that has Helix DRM protection. Details related to managing digital rights of media content in a media network of media devices are disclosed in co-pending U.S. patent application having Express Mail No. ED 869153144 US, Attorney Docket No. IS01951TC, and entitled “System and Method for Collecting and Routing Media Content in Media Network.” which is filed concurrently herewith and is incorporated herein by reference in its entirety.

With an understanding of the information maintained in the master manifest file 300, the present disclosure now returns to FIG. 2 to illustrate how the media network manages resources of network 100 for delivering media content. As noted above, the manifest file 300 stores information on the available resources in the manifest file 300 so that the central server 110 is prepared to manage the delivery of media content to a user when the user makes a request for media content.

In one example of the operation of the network 100, the user may be interested in listening to music on her portable music player 140 while at home, and she makes a request for media content (i.e., a music file) stored on the network 100 using her portable music player 140. In this regard, the various media devices 120, 140, and 150 and even the central server 110 may be capable of storing media content separately, and the user can access information about such stored media content and its location on the network 100 from her portable music player 140 when making the request.

After the request is initiated, the server 110 determines which functions are required to deliver the requested media content to the user. For example, the server 110 determines where the media content is stored on the network 100, determines what type of file (e.g., MP3, MPEG, etc.) the media content is, and determines what form of processing is required to deliver the media content to the receiving device in question, which in this case is the portable music player 140. Then, the server 110 reviews the master manifest file 300 and determines the current, real-time processor usage and the capabilities of the media devices 120, 140, and 150 active on the network 100. From an analysis of the master manifest file 300 coupled with the functions required to deliver the requested media content, the server 110 finally determines an arrangement of the media devices 120, 140, and 150 to processes and deliver the media content to the user.

Several arrangements of the media devices 120, 140, and 150 may be available on the network 100 for delivering the music to the portable music player 140. In one arrangement, the music player 140 can perform all of the storing and processing functions required. In other arrangements, the functions required to deliver the music can be distributed among the active devices 120, 140, and 150 on the network 100. One or more of the arrangements may not be possible due to the current configuration of the network 100 and capabilities of the active media devices 120, 140, and 150. Moreover, one of the possible arrangements may be more efficient than other possible arrangements. Therefore, the server 110 determines what arrangement to use to deliver the music based on the nature of the request and based on the analysis of the current information in the master manifest file 300.

For example, the requested media content may be an MP3 file stored at the music server 120. The manifest file 300 may indicate that (1) the remote music server 120 has current processor usage of 30% and has capabilities of MP3 storage, MP3 parsing, MP3 decoding, and pulse code modulated (PCM) streaming; (2) the music player 140 has a current processor usage of 10% and has capabilities of MP3 storage, MP3 decoding, PCM streaming, and audio rendering; and (3) the vehicle device 150 has a current processing usage of 15% and has capabilities of MP3 storage, MP3 decoding, and audio rendering.

The manifest file 300 may also indicate the current throughput or other communication speeds available with the media devices 120, 140, and 150, as previously noted. For example, both the music server 120 and music player 140 may be located close together in the network 100 (e.g., the user may have her portable music player 140 in her home and near the music server 120), a determination which could be made by location information provided in field 304 of the master manifest file 300 (not shown in FIG. 3. Therefore, the music server 120 and music player 140 may be capable of short-range wireless communication through a wireless home gateway so that the current throughput for the music server 120 and music player 140 may be 10 MBit/sec. On the other hand, the vehicle device 150 may not be in close proximity to the music server 120 or player 140. Thus, a number of communication paths, such as a wireless cellular network and the Internet, may be required to communicate information to and from the vehicle device 150 so that the current throughput for the vehicle device 150 may be only 0.5 MBit/sec.

Based on the information in the manifest file 300, the server 110 would logically determine that the remote music server 120 should stream the requested music to the music player 140 via a communication link 107 so that the user can listen to the music on the portable music player 140. As just noted, the communication link 107 can involve wireless communication via a wireless gateway in the home domain, for example. Therefore, the server 110 directs the music server 120 to decode the MP3 content and stream the PCM stream to the music player 140 via communication link 107, which has a throughput of 10 MBit/sec. Due to the lower throughput, processor usage, processing capabilities, etc. of the vehicle device 150, the server 110 may have determined that the capabilities of the vehicle device 150 are not currently required or best suited to deliver the music to the user.

Changes, however, may occur in the network 100. In one example, the user may move an active media device from one domain to another (e.g., take her portable music player 140 from her home domain to her vehicle domain) so that the communication paths between the media devices 120, 140, and 150 must be reconfigured. In other possible changes, one of the active media devices 120, 140, and 150 may disconnect from the network 100, or the user may make an additional request on the network 100. The server 110 monitors for such changes and makes new determinations to seamlessly deliver the media content to the user.

For example, the user, who is listening to music on her portable device 140 while at home, may subsequently enter her vehicle 156 and may submit a request that the music currently playing on her portable player 140 be delivered at the vehicle device 150 instead. To initiate such a request, the user may enter commands using a vehicle interface (not shown) of the vehicle device 150, such as disclosed in the incorporated U.S. patent application having Express Mail No. ED 869153144 US (Dkt. No. IS01951TC).

Even though the user has requested the music at the vehicle device 150, the vehicle device 150 may not have the required storage and processing capabilities to enable it to store and render the music locally to the user entirely on its own. Therefore, the server 110 again uses the information in master manifest file 300 to determine which functions are required and which active media devices 120, 140, and/or 150 have the required functions to deliver the music to the user.

Based on the analysis of the network resources in the manifest file 300, the server 110 may determine, for example, that the music server 120 should parse the MP3 content and send the parsed MP3 content to the music player 140 via a first communication link 107. This first communication link 107 may involve the Internet and a cellular wireless connection between the music server 120 and the portable music player 140, for example. In turn, the server 110 may determine that the music player 140 should decode the MP3 content and stream the PCM audio to the vehicle device 150 via a second communication link 108. This second communication link 108 may involve a short-range wireless connection between the portable music server 140 and the vehicle player 150, for example. Finally, the server 110 may determine that the vehicle device 150 should render the PCM stream to deliver the music to the user with the vehicle device 150. Having made this determination, the server 110 sends instructions to the media devices 120, 140, and 150 to configure processing of the music. The music is then processed using the media devices 120, 140, and 150 so that the music can be delivered at the vehicle device 150 as requested.

Based on the above example, it will be appreciated that server 110 can determine that any combination of media devices on the network 100 can be used to process the requested media content and eventually deliver the processed media content to the final requested device. Furthermore, the various media devices can each perform different content processing of the media content, such as encoding, decoding, transcoding, parsing, rendering, decrypting, encrypting, or combinations thereof. For example, the server 100 can determine to perform decoding the media content (e.g., MPEG2) at one device and sending the decoded file to the final requested device for parsing and rendering. In another example, the server 100 can determine to perform decryption on one media device, transcoding (e.g., MPEG4 to MPEG2) on another media device, decoding on yet another media device, and streaming of the audio and video to the final requested device.

Now that details of the centralized media network 100 have been described with reference to FIG. 2 and details of master manifest file 300 have been described with reference to FIG. 3, the present disclosure now turns to a discussion of a process for managing such a centralized media network.

In FIG. 4, an embodiment of a process for managing a centralized media network is illustrated in flow chart form. A central server monitors the centralized seamless mobility network for those devices actively connected to the network (Block 410). During the monitoring, the central server receives and stores manifest files of the active media devices in a main manifest file or database (Block 412). For example, manifest files can be received when a media device enters the network. In addition, the central server can periodically poll each active device for a current manifest, or each device can be pre-configured to send a current manifest to the central server routinely. Of course, when a media device enters the network, the central server can add data in the manifest file for the entering device. In addition, when a media device leaves the network, the central server can delete the data in manifest file for the leaving device or can render the data inactive. Thus, the process 400 can further act to back up operation of the system to ensure the successful continuation of operation should there be a fault or reconfiguration of the media devices active on the network.

Next, the central server awaits a user to initiate a request on any of the active devices on the network (Block 414). When a user makes a request (i.e., to play a movie on the user's Telematics system in a vehicle), the central server receives the request (Block 416) and compares the manifests of the devices stored in the main manifest database (Block 418). In other words, the server analyzes the available network resources (e.g., functions, capabilities, current processor usage, and current connection data) from the manifest file.

The central server determines from the comparison whether sufficient resources currently exist to execute the request (Block 420). If the current resources are insufficient, the central server notifies the user that the action cannot be executed (Block 440). The central server can then await another request from a user (Block 414). Alternatively, in the event that a new device with the missing resources has entered the network, the central server can again compare the information stored in the main manifest database to determine another solution (Block 418).

If resources are determined sufficient at Block 420, the central server determines the appropriate allocation of those resources to execute the request (Block 422). The central server then contacts each determined device by sending an allocation request or command to the device (Block 424). Communicating the allocation request from the server to the media devices can be accomplished using techniques known in the art.

After sending the allocation request, the central server then determines whether the various devices have acknowledged the requests (Block 426). Communicating acknowledgements can also be accomplished using techniques known in the art. If one or more of the contacted devices has not returned an acknowledgment, the central server may notify the user that the action cannot be executed (Block 440) and may await another request (Block 414). Alternatively, the central server can again compare information in the manifest file to determine whether another (possibly less efficient or reliable) arrangement or allocation of available resources can be used to execute the request (Block 418).

If all of the contacted devices have acknowledged the allocation requests from the central server at Block 426, the central server then executes the user's request (Block 428). To execute the user's request at Block 428, the central server can send specific instructions to each of the devices using techniques known in the art. The instructions indicate how to process (decode, encode, render, stream, etc.) the media content and how to communicate the content with the various media devices of the network, such as in the example disclosed above with reference to FIG. 2. When resources are allocated to handle the request, the information in the manifest file is updated to reflect the current resource usage of the active media devices (Block 430). Ultimately, the central server can await another request from the user after executing the request (Block 414).

In contrast to the centralized media network discussed above with reference to FIGS. 2 through 4, embodiments of the present disclosure can also involve a decentralized media network that lacks a central server. Referring to FIG. 5, an embodiment of a decentralized or distributed media network 101 is illustrated. As with the centralized media network discussed above, the decentralized media network 101 of the present embodiment includes a plurality of media devices 120, 140, and 150 in various domains, such as vehicle, home, and person. In addition, the media devices 120, 140, and 150 connect to the network 101 using one or more communication paths of network 106 known in the art or disclosed herein. Because it is decentralized, the network 101 does not include a central server. Instead, the functions for managing the delivery of media content are distributed among the device 120, 140, and 150 of the network 101.

Much of the details related to maintaining information on available resources and other details of the network 101 are the same those of the centralized media network discussed previously. The decentralized media network 101, however, differs in how it maintains information on the available resources of the network 100 and how it allocates those resources to deliver media content efficiently. For example, each media device 120, 140, and 150 maintains its own copy of the master manifest file 300′, which contains information about the resources of the media devices active on the network 100. Because there is no centralized location (i.e., central server) to gather information, the active media device 120, 140, and 150 preferably share information to keep the copies of the master manifest files 300′ current. In addition, without a central server to instruct the media devices 120, 140, and 150 on how to assess and process media content in response to a user's request, the active media device 120, 140, and 150 must instead negotiate instructions amongst themselves to accomplish this task.

To illustrate the differences of gathering information and allocating resources, an example of the operation of the decentralized media network 101 is discussed. At some point during the operation of the network 101, the user may have her portable music player 140 connected to the network 101 and may be listening to music being streamed from the remote music server 120 via a first communication link 107. The user may then enter her vehicle 156 and may request to hear the music at the vehicle device 150. Rather than have a central server determine the allocation of resources required to deliver the music to the vehicle device 150, the active media devices 120, 140, and 150 negotiate amongst themselves to configure the network 101 and allocate the available resources efficiently.

Thus, the vehicle device 150 determines from its master manifest file 300′ whether it has the required resources to process the audio content for the user's request. The vehicle device 150 may have limited storage and processing capabilities so that it may lack all of the required resources to deliver the music by itself. Alternatively, playing the music solely with the vehicle device 150 may be inefficient use of the network's resources. Therefore, the information on the other media devices 120 and 140 in the manifest file 300′ is also analyzed to determine whether those devices 120 and 140 have required resources to process the music or at least to request if such devices are willing to do so. Based on the analysis, the vehicle device 150 determines which active media devices 120, 140, and 150 have the required resources. The vehicle device 150 then sends instructions to the other media devices 120 and/or 140 to configure the delivery of the music. Then, the music is processed using the determined media devices and is delivered to the user at the vehicle device 150.

For example, the analysis of the manifest file 300′ may show that the music server 120 should parse MP3 content and send the parsed MP3 content via a first communication link 107 to the portable music player 140 that the user has in the vehicle 156. Furthermore, the analysis may determine that the portable music player 140 should then decode the parsed MP3 content and stream the PCM audio to the vehicle device 150 via a second communication link 108.

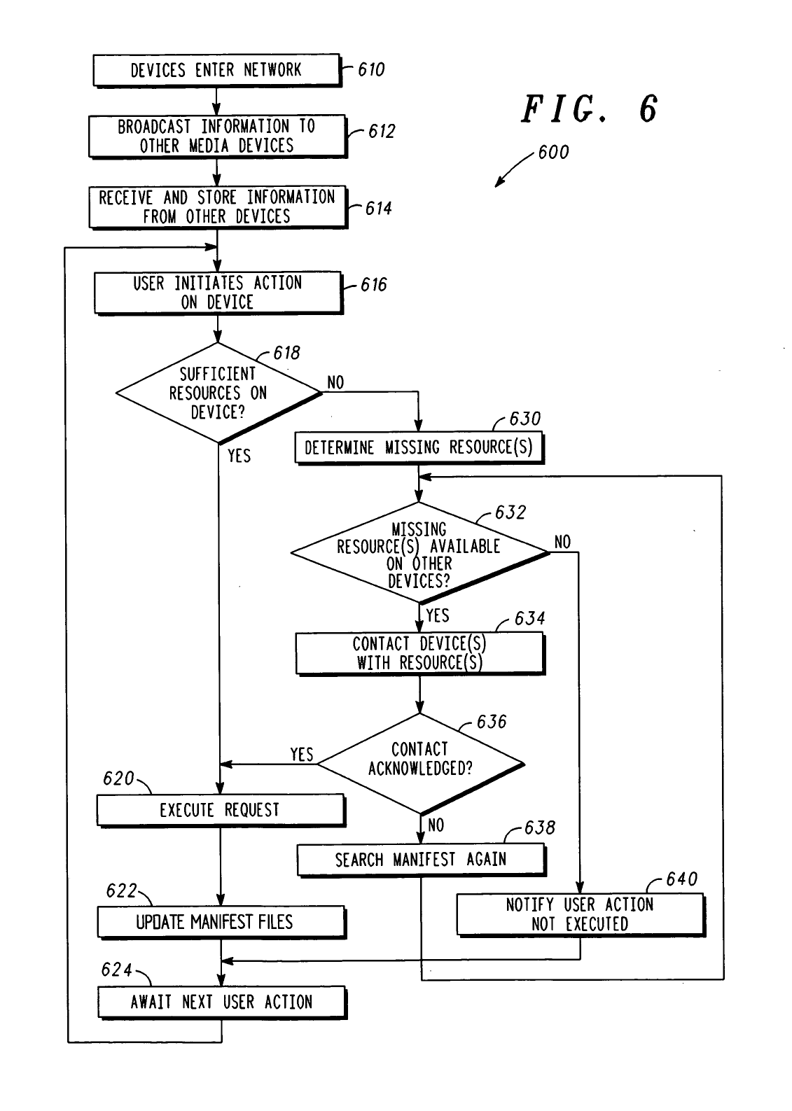

In FIG. 6, an embodiment of a process 600 for processing a user's request in a decentralized network is illustrated in flowchart form. Initially, media devices enter the network (Block 610). The entering media devices may be entirely unknown or may be already known or recognized by other media devices in the network. In either case, entering the network involves various forms of network negotiating and communication between the media devices. After entering the network, for example, the media devices broadcast or communicate their information to the other devices currently active on the network (Block 612). Communicating the information can be accomplished using techniques known in the art, such as Universal Plug and Play (UPn™) technology. In response to the information, each of the other media devices receives the information and stores it in a local manifest database (Block 614).

Now that information of active media devices has been shared, operation of the decentralized network can proceed as follows. The user initiates a request for media content on one of the media devices (Block 616). For example, the user requests a movie to play on her vehicle device. In response, the vehicle device performs various actions to negotiate available resources on the network and to facilitate efficient use of those resources. First, the vehicle device determines from the local manifest file whether it alone has sufficient resources to satisfy the user's request to play the movie (Block 618). Making this determination first may save subsequent processing requirements if the vehicle device has the storage and processing capabilities to play the movie on its own. The vehicle device can further determine whether satisfying the request with its own resources would make optimal use of the resources available on the network. This subsequent determination involves a comparison of the capabilities of the vehicle device with information of the other media devices stored in the local manifest file. If the vehicle device can satisfy the user's request (e.g., play the movie) efficiently on its own, then the system executes the request (Block 620). After resources are allocated to handle the request, the information in the manifest files is updated to reflect the current resource usage of the active media devices (Block 622). Ultimately, the system can await any additional user action or request (Block 624).

When determining resources at Block 618, however, the vehicle device may determine that it lacks all the required resources to execute the user's request either efficiently or on its own. For example, the vehicle device may have limited storage capacity or a less efficient processing or decoding capabilities to render the movie. Therefore, the vehicle device determines which resources are missing from its own capabilities to satisfy the user's request (Block 630). Then, from the manifest file stored locally, the vehicle device determines whether the missing resources are available from other devices on the network (Block 632). If the resources are found, the vehicle device contacts the other remote media devices and requests allocation of those resources (Block 634). Each remote device receiving the requested allocation compares its currently available resources with the requested allocation, sends back confirmation or declination to the vehicle device, allocates the resources, and performs other appropriate tasks.

After making contact with the other media devices, the vehicle device determines whether the other media devices have acknowledged the requested allocation of resources (Block 636). If so, the vehicle device in conjunction with the other devices can then execute the user's request (Block 620). After resources are allocated to handle the request, the information in the manifest files is updated to reflect the current resource usage of the active media devices (Block 622). Ultimately, the vehicle device can await the next request from the user (Block 624).

If other media devices, however, fail to acknowledge the requested allocation, which may be due to miscommunication, old manifest files, or other reasons, then the vehicle device searches its local manifest file again for available resources from other active media devices on the network (Block 638). During its search, the vehicle device may determine that the user action cannot be currently executed with the available resources on the network. Therefore, the vehicle device notifies the user that the action cannot be currently executed (Block 640) and awaits the next action from the user (Block 624).

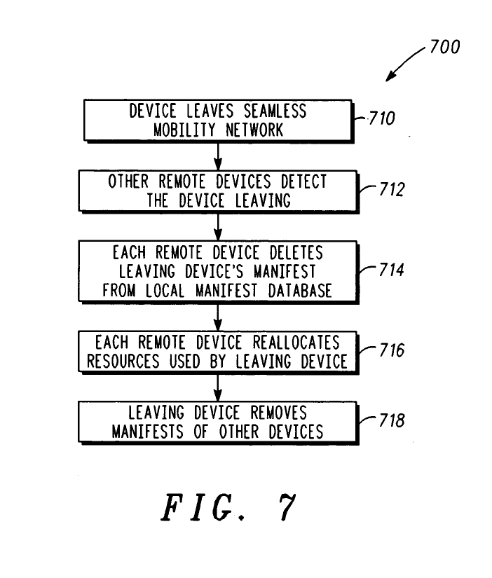

As evidenced by Blocks 610 through 614, information in the manifest files is updated when media devices enter the decentralized network. The same is also true when an active media device leaves the network. In FIG. 7, an embodiment of a process 700 for reallocating and updating resources when a media device leaves the decentralized network is illustrated in flowchart form. First, a media device, such as the vehicle device, initiates actions to disconnect or leave the network (Block 710). The other media devices detect the vehicle device leaving the network using the techniques known in the art (Block 712). In response, each of the other media devices either deletes the leaving vehicle device's information from its local manifest file or renders the vehicle device's information inactive (Block 714). If one of the other media devices remaining on the network was currently using resources of the leaving vehicle device, that remote device renegotiates the reallocation of those resources according to the techniques disclosed herein (Block 716). Then, the leaving device can leave the network and remove all the information of the other remote devices stored in its local database (Block 718).

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of managing media content in a network, the network having a plurality of media devices connected to the network by a plurality of communication paths, the method comprising:
storing information at each of the media devices, the information at least including content processing functionality and throughput capacity for each of the media devices, wherein content processing comprises converting media content;
receiving a request for delivery of media content at a requesting media device;
determining from the information which one or more media devices are capable of providing the requested media content;
sending instructions from the requesting media device to the determined media devices to configure the content processing of the requested media content;
content processing the requested media content using the content processing functionality at least one of the determined media devices; and
sending the processed media content to the requesting media device.

2. The method of claim 1, wherein the act of content processing comprises at least on of: encoding, decoding, transcoding, parsing, rendering, decrypting, encrypting, or a combination thereof.

3. The method of claim 1, wherein the act of sending the processed media content to the requesting media device comprises at least one of the following:
streaming the processed media content; or
sending the processed media content in a form capable of being parsed and rendered by the requesting media device.

4. The method of claim 1, further comprising updating the information to reflect resource usage related to the content processing of the requested media content and the sending of the processed media content.

5. The method of claim 1, wherein the media content is selected from the group consisting of multi-media data, audio data, video data, cable broadcast data, radio broadcast data, satellite broadcast data, and television broadcast data.

6. The method of claim 1, wherein the act of determining comprises:
determining the content processing required to provide the requested media content; and
comparing the required content processing to the information of the media devices to determine which media devices can provide the required content processing.

7. The method of claim 1, wherein the requested media content comprises restricted media content, and wherein the act of determining from the information which one or more media devices are capable of providing the requested media content comprises determining which media device has a right to process the restricted media content.

8. The method of claim 1, wherein the act of determining comprises comparing the throughput capacities for the media devices to determine which media devices can provide the media content.

9. The method of claim 1, wherein the information stored for each of the media devices comprises processor capacity for each of the media devices, and wherein the act of determining comprises comparing the processor capacities for the media devices to determine which media devices can provide the media content.

10. The method of claim 1, further comprising sharing information between each of the media devices actively connected to the network to store the information at each of the active media devices.

11. The method of claim 1, further comprising reconfiguring the content processing of the requested media content in response to a media device leaving or entering the network.

12. A method of managing media content in a network, the network having a server and a plurality of media devices connected to the network by a plurality of communication paths, the method comprising:
storing information at the server, the information at least including content processing functionality and throughput capacity for each of the media devices on the network, wherein content processing comprises converting media content;
receiving a request at the server from a requesting media device for delivery of media content;
determining from the information at the server which one or more media devices are capable of providing the requested media content;
sending instructions from the server to the determined media devices to configure the content processing of the requested media content;
content processing the requested media content using the content processing functionality at least one of the determined media devices; and
sending the processed media content to the requesting media device.

13. The method of claim 12, further comprising updating the information at the server to reflect resource usage related to the content processing of the requested media content and the sending of the processed media content.

14. The method of claim 12, wherein the act of determining comprises:
determining the content processing required to provide the requested media content; and
comparing the required content processing to the information of the media devices to determine which media devices can provide the required content processing.

15. The method of claim 12, further comprising monitoring the media devices actively connected to the network with the server to store the information on the active media devices.

16. The method of claim 12, further comprising reconfiguring the content processing of the requested media content in response to a media device leaving or entering the network.

17. A media managing system, comprising:
a server communicatively connected to a network of media devices, the server configured to:
store information at least including content processing functionality and throughput capacity for each of the media devices on the network, wherein content processing comprises converting media content;
receive a request from a requesting media device for delivery of media content;
determine from the information which one or more media devices are capable of providing the requested media content;
send first instructions to the determined media devices to configure the content processing of the requested media content, whereby the content processing functionality at least one of the determined media devices performs the content processing of the requested media; and
send second instructions to the determined media devices to configure sending of the processed media content to the requesting media device.

18. The system of claim 17, wherein the server is further configured to update the information to reflect resource usage related to the content processing of the requested media content and the sending of the processed media content by the determined media devices.

19. The system of claim 17, wherein the media devices are selected from the group consisting of a portable electronic device, a cellular communication device, a home entertainment system, a personal computer, a vehicular entertainment system, and a media source.

20. The system of claim 17, wherein the media content is selected from the group consisting of multi-media data, audio data, video data, cable broadcast data, radio broadcast data, satellite broadcast data, and television broadcast data.

21. The system of claim 17, wherein the information stored for each of the media devices at the server comprises processor capacity for each of the media devices, and wherein to determine from the information which one or more media devices are capable of providing the requested media content, the system is configured to compare the processor capacities for the media devices to determine which media devices can provide the media content.

22. The system of claim 17, wherein the server is further configured to monitor the media devices actively connected to the network, and store the information on the active media devices.

23. The system of claim 17, wherein the server is further configured to reconfigure the content processing of the requested media content in response to a media device leaving or entering the network.
